(19) United States
(12) Patent Application Publication
(10) Pub. No.: US 2005/0243807 A1
(43) Pub. Date: Nov. 3, 2005

(54) Method of searching a specific computer IP address using telephone number codes and an identification code

(76) Inventor: Chung-Yu Lin, Kaohsiung City (TW)

Correspondence Address: BACON & THOMAS, PLLC, 625 SLATERS LANE, FOURTH FLOOR, ALEXANDRIA, VA, 22314, US

(21) Appl. No.: 11/116,248

(22) Filed: Apr. 28, 2005

Related U.S. Application Data
(60) Provisional application No. 60/566,418, filed on Apr. 30, 2004.

(51) Int. Cl. H04L 12/66

(52) U.S. Cl. 370/352

(57) ABSTRACT

A method of accessing a website, e-mail server, or voice communication device involves associating a domain name and/or e-mail address with a telephone number and identification code. When a user enters the telephone number and identification code, a search of a database(s) is carried out for a domain name, e-mail address, or IP address associated with the telephone number and identification code, and of a match is found, the user is immediately directed to the website associated with the domain name, an e-mail is directed to the corresponding e-mail address, and a request for voice communication is directed to a corresponding IP address of the voice communication device.

This application claims the benefit of provisional application No. 60/566,418, filed Apr. 30, 2004.

### BACKGROUND OF THE INVENTION

As everyone knows, use of the Internet and World Wide Web (www) has become indispensable for living and daily work. Roughly estimating, the population of World Wide Web users is over 2 billion, and keeps on increasing. These facts prove that twenty first century is a network era. The network has replaced many traditional living functions or become an alternative to them. The most popular applications include website browsing, transmission of information, e-mail message transferring in the form of text and pictures, and exchange of on-line voice communications (i.e. Internet-phone).

Under favorable conditions of constantly increasing Internet bandwidth and continuously decreasing access charges, the population of Internet-phone users is increasing rapidly and substantially, and most likely will exceed that of conventional telephone users in the near future.

However, due to daily increases in the frequency of website visits and mass circulation of e-mail, as well as the increasing popularity of Internet-phone usage, some drawbacks have become apparent, as described below:

A. For the Website:

1. Many large-scale enterprises and corporation set up a proprietary website of their own. By means of the proprietary website, the business can integrate its midstream and downstream satellite factories to achieve effective mass production.

This kind of B-to-B (Business to Business) website is not open to the public, but is exclusive to those associated with particular businesses, and serves as a commercial platform for mutual production.

It is often heard how such B-to-B websites have become the target of invasion and congestion, and are subject to crashing upon being overrun by “web-highjackers,” in which case the businesses thus their peripheral businesses and midstream and downstream factories fail to access the website, resulting in disorder of normal production operation with incalculable loss. To avoid malfunction and delay of the website, a large amount of capital is wasted to set up firewalls and counter-mechanisms, entailing extra software costs and causing the businesses to suffer from inexpressible torment.

2. Some academic or educational websites with a specific function are exclusively open to those associated with the educational institution to serve as a knowledge platform for mutual academic exchange. Although the public is prohibited access, the same drawbacks as occur with B-to-B websites will happen inevitably. This situation un-expectably continues and causes uncertain losses in consequence of severely hampered academic exchange.

3. Since the advent and initiation of the World Wide Web, the number of websites established is over 25 million (including personal websites and different corporate websites) under conservative estimation, and constantly increases. The domain name is a set of character symbols representing the IP Address (Internet Protocol Address) of a host computer on the Internet. The IP Address is made up of four sets of decimal numerical numbers (0˜255) arranged and composed in sequence. For example, the IP Address of Yahoo! Kimo is “http://202.1.237.21.” Such an IP address is obviously difficult to memorize. To make it easy to remember, it is replaced by the domain name. Due to uniqueness limitations of specific domain names, ICANN (The Internet Corporation for Assigned Names and Numbers), has been established as an organization to supervise and manage the worldwide DNS (domain name system), which adopted seven categories (.com &.org &.net &.gov &.int &.mil &.edu) of gTLD (generic Top Level Domains) in 1985, and announced additional gTLDs, including .aero, .biz, .coop, .pro, .info, .name, .museum etc. in May of 2001.

In view of this trend, the number of domain names will increase instead of decrease in the future. Concurrently, disputes and drawbacks derived from domain names will increase too, for the following reasons:

(1) Because a domain name has the property of uniqueness and follows a rule of preemption in registration (first come, first served), it excludes many willing users who would like to have the same domain name. Because virtually no examination occurs during registration, anyone of interest can apply for any admirable domain name. Once registered, the domain name is absolutely exclusive. In the future, everyone is prohibited from applying for or using the registered domain name again, irrespective of whether the applicant is in the same business. For general business, a well-known domain name not only can attract customers to visit a website and create business opportunities, but more importantly can represent the product and service and build an entrepreneurial image. Especially in the era of E-commerce, a simple, outstanding, memorable, indicative, touching and impactful domain name, which may or may not be the same as the business name, is desirable and invaluable as well as a principal way of attracting customers. Therefore, it causes many Cyber-squatters to register domain names related to famous businesses, trademarks and persons to keep them as assets to resell (or extort) from businesses or person of interest to achieve extortionate windfall profits

(2) It is extremely bothersome for the general user of the Internet to memorize a lot of particular domain names. Therefore, for some domain names that are difficult to memorize, the user needs to obtain help by diligently keeping records on his personal notebook or in a special file in a PC of his own to avoid forgetting the domain names and being unable to browse the specific objective website in mind. Additionally, B2B (or B to B or Business to Business) is very popular in E-commerce. For a businessman, time is efficiency; and the purpose of accessing a specific objective website (including a website of his or her proprietary upstream and downstream companies and websites of customers to visit) is to quickly get into it successfully instead of leisurely roaming around websites without urgency. Frequently, the web user can only remember the company name but is not sure of the domain name of the company. For most people, it is easy to memorize a simple company name but difficult to recall a domain name made up of lengthy series of character symbols. Similarly, it is easy to memorize the name of a person but difficult to recall a domain name of such person.

To solve both main drawbacks, namely the problem of cyber-squatters and domain name memorizing difficulties, the inventor of the present case, Lin Chung Yu, has already submitted copending U.S. patent application Ser. No. 10/040,311, filed Dec. 31, 2001 and now allowed (Published Application Number: U.S.-2003-0126119-A1; Title: Method of searching a specific website by means of a numerical code combined from a plurality of specific phone numbers; Publication Date: Jul. 3, 2003) The specification of the copending application provides a detailed description of a solution to both problems.

The solution is to combine the local telephone number, which is exclusively owned by a person or a company, with a country code number and area code number into a numerical sequence. The numerical sequence is arranged in the order of “country-code-number+area-code-number+local-telephone-number” and associated with a specific domain name, which is exclusively owned by a person or company. Then, both the numerical code and domain name are registered and stored in any website server in the Internet.

When any user of the Internet wants to contact another website of a person or a company, through orderly keying in the “country-code-number+area-code-number+local-telephone-number” numerical code of such person or such company into the code entry field on the search interface dynamic web page of his particular website, by means of a search program in the server of such particular website, the user can access the database in such server or any other database in the other server of the other website connecting with the World Wide Web to proceed with searching and comparison of his keyed-in numerical search code on such database, thus finding out a matched phone code and its corresponding domain name of the target website, which is immediately connected-to automatically. As a result, the user can precisely achieve access and browse on the specific objective website, which he wants to contact.

Since the inventor of the present case submitted the application for patent, he set up a website of “www.2 umail.com” in accordance with the method described in the copending application to practically carry out the method. The advantages are as below:

(1) The acquired telephone-number of a person or a company being allocated and designated by the telecommunication agency with country-code-number and area-code-number becomes unique and exclusive in the world. It not only prevents repeated acquisition by other people, but also forestalls registration of a specific domain name since the only a party possessing the unique telephone number can register a domain name associated therewith, thus precluding and eliminating the vicious extortion carried out by cyber-squatters.

(2) By means of the existing complete mechanism of telephone-number acquisition, converting the difficult-to-memorize domain name into a telephone number-accessible domain name enables the user of the Internet to be free from the time-wasting and tedious job of memorizing a lengthy domain name. Whenever and wherever, he can easily look up and inquire about the objective telephone number, which he wants to contact, through any channel available such as a local telephone book, directory service center, or directory service website in the Internet. As a result, the user can immediately access and browse the objective website arrived-at through the telephone number. Thus, the difficulty of accessing and browsing a website will significantly decrease, and the visiting frequency of the website will be greatly increase.

B. For e-mail:

It is well-known that every user of the Internet has to apply for an e-mail address through the ISP or Internet Service Provider. As described above, the e-mail address actually stands for the IP Address or Internet Protocol Address of the e-mail server in the Internet.

An e-mail of obscure origin is so-called “garbage e-mail,” also known as junk e-mail or spam, which typically originates from a single source and is disseminated to many e-mailboxes. Roughly estimating, approximate 40%˜80% of received e-mail in the current industry belongs to “garbage e-mail,” and the amount is increasing. The constantly increasing flow rate of “garbage e-mail” not only causes people to feel disgusted, but also seriously affects the normal operation of a business, thus reducing the productivity and augmenting the production cost. Therefore, how to preclude the overrun of the “garbage e-mail” has become a pressing issue.

However, a prerequisite to solving the problem of garbage e-mail is to understand the ways that people who spread such garbage e-mail collect e-mail addresses. These ways can be generalized as follows:

1. Forward e-mail:

Some web-mates do not exercise confidentiality or clean up all the messages previously forwarded, and thus create web grapevines or rumors and spread pictures, information or subroutines etc. which some opportunists will find the loopholes to exploit. That is the most prevalent way to collect e-mail addresses.

2. Providing by Website:

Some websites with a gratis membership account will require entry of e-mail addresses, causing the addresses to receive garbage e-mail simply by registering an account. This is partly because the e-mail service provider sells the customer database to get profits for the purpose of survival, and partly because a internal hidden traitor might sell customer database secretly. It is also possible due to inadequate in the safety mechanism of a website for the system to be invaded by a web-highjacker, who purloins the member information.

3. Message Bulletin Board:

An automatic searching program can search and collect e-mail accounts in a VR (Virtual Reality) system such as a BBS (Bulletin Board System) or message board and discussion area or forum, where the author's e-mail address to be retrieved easily. In other words, the more exposed an e-mail account is, the more garbage will be received thereby. If one has the intent, one can compile such a program and run it to do searching comparison, and obtain a plentiful harvest.

4. Method of Try-and-Error:

For some popular websites with e-mail service such as Yahoo and Hotmail, one can use the try-and-error method to search and collect e-mail addresses. Combining popular names and numbers such as John, Mary, Jason etc. together with 001, 002, etc. as a search code, one can get abundant e-mail address list like John@yahoo.com or Mary001@hotmail.com.

5. Private Collect:

Currently, many people have proprietary webpages with a “contact us” option on it. Such web page configurations expose the e-mail address. A person who has the intent to collect the e-mail address can easily obtain related IP addresses through such a “contact us” option.

Because of all the aforementioned methods of harvesting e-mail addresses, we know that the e-mail addresses can easily be found out by people whose intent is to collect the addresses and harass or swamp the owners.

C. For On-Line Voice-Communication of the Internet:

Thanks to the favorable trends of constantly increasing bandwidth for the Internet and increasing transmission speed, using the Internet as a real time on-line Voice-Communication medium has become a trend surpassing its original main function of text communication for the users. Because the communication fare rate of the Internet is much lower than that of the conventional telephone, the population of PC-using-workers has increased, and real time on-line Voice-Communication on the Internet indirectly steps up to replace the conventional telephone in international long distance calls.

However, currently the operation of using a PC for real time on-line Voice-Communication over the Internet has following drawbacks:

1. As we all know, any computer connecting to the Internet has its exclusive IP address. Such an IP address is difficult to memorize as it is combined by 4 sets of decimal numerical numbers. For example, the host IP address of the famous engine website Yahoo!Kimo is http://202.1.237.21/. The long string of numbers in series in the illustrated IP address have nothing to do with each other and are meaningless as well as irrational, thus making it difficult for normal people to remember. When a calling party operates with on-line voice-communication, he must key in the exclusive host IP address of the objective recipient in order to accomplish the mutual on-line voice-communication. As long as any numerical code of such host IP address is wrong during key-in entry, the connection will fail. Therefore, the user needs to help by diligently keeping records in his or her personal notebook or in a special file in a PC of his or her own to avoid forgetting the numbers or provide a wrong key-in entry. Concurrently, the greater the number of target contacts wanted in voice-communication, the greater the number of required records that must be kept. Eventually, it becomes very difficult to management and very inconvenient.

2. When going abroad or traveling outside, the user can easily encounter the situation that the PC used to access a website does not belong to the user. Since it is not the PC customarily used, the user cannot find out the stored host IP address of the objective recipient of an e-mail in the PC files. Unless the user happens to carry a personal notebook having such information, the user must painstakingly call for help by means of a telephone to ask other people to inquire about the host IP address of the recipient. Such trouble still continuously happens everywhere in the world.

3. Due to the trend of mass utilization of on-line voice-communication, unexpected calling harassment is inevitable. Just like traditional telephone harassment, the user of on-line voice-communication will suffer from many voice-communications coming from an irrelevant source or obscure origin, and thus will be pestered unbearably instead of being able to access objective people who really wants to contact through such on-line voice-communication. Therefore, how to preclude such kind of calling harassment coming from an irrelevant source or obscure origin becomes an important and indispensable objective.

### SUMMARY OF THE INVENTION

A main object of the present invention is to provide a “method of searching a specific computer IP address of Internet networks using several specific telephone numbers which are arranged and composed in sequence with additional identification codes.” According to the invention, a numerical code is made up of an exclusive local telephone number of a person or a company, a country code of the person or company, an area code of the person or company, and an additional identification code, which is designated by such person or company, and is arranged in sequence of “country-code+area-code+local-telephone-number+identification code(s).” Then the numerical code, together with the exclusive domain name corresponding to the specific website of such person or such company is concurrently registered together in a server of the predetermined website, or any server of any website connected to the Internet.

When a user of the Internet having the information of such numerical code corresponding to such website wants to visit, he can first orderly key-in the numerical code of “country-code+area-code+local-telephone-number+identification code(s)” corresponding to such IP address through the search-interface-dynamic-web-page in the server of the specific website. Then, the search programs in the server of the website will automatically access a database in the website to perform a search and select a domain name matching the numerical code. Thus, the user is immediately connected to the website corresponding to the domain name of such person or company automatically in order to let the user to achieve the purpose of visiting and browsing such website.

Another object of the present invention is to provide a method of searching a specific e-mail address using several specific telephone numbers in series which are arranged and composed in sequence with additional identification codes. According to the invention, the numerical code is again made up of an exclusive local telephone number of a person or a company, a country code of the person or company, an area code of the person or company, and an additional identification code, which is designated by such person or company, and is arranged in sequence of “country-code+area-code+local-telephone-number+identification code(s).” Then the numerical code, together with the exclusive e-mail address of such person or such company, is concurrently registered together in the server of the predetermined website or any server of any website connected to the Internet.

When a sender of the e-mail having the information of such numerical code corresponding to such subjective recipient of a person or a company wants to send his e-mail to such recipient, he can first orderly key-in such numerical code of “country-code+area-code+local-telephone-number+identification code(s)” corresponding to such IP address through a Code Entry Field in the search-interface-dynamic-web-page to the e-mail server or other server of any website connected to the (www). Then, the search programs in such server of such website will automatically access the database in such website to perform searching comparison to screen and to select out an e-mail IP address matching with such numerical code. Thus, the user is immediately connected to the corresponding e-mail IP address of the subjective recipient automatically in order to let such e-mail sender achieve the purpose of sending such e-mail to such subjective recipient's specific POP e-mail server.

Another object of the present invention is to provide a method of searching a specific IP address of a voice-communication device connected to the Internet, using several specific telephone numbers in series which are arranged and composed in sequence with additional identification codes. According to this object, the numerical code combines the exclusive local telephone number of a person or a company, a country code, an area code, and an additional identification code, which is designated by such person or company, and is arranged in sequence of “country-code+area-code+local-telephone-number+identification code(s)”. Then the numerical code and the additional identification code, together with the exclusive host IP address corresponding to a specific voice-communication device of such person or such company are concurrently registered together in such server of the predetermined website or any server of any website connected to the Internet.

When a caller of the voice-communication having the information of such numerical code corresponding to such subjective taker of a person or a company wants to call to the subjective receiver, he can first orderly key-in such numerical code of “country-code-number+area-code-number+local-telephone-number+identification code(s)” corresponding to such IP address through a Code Entry Field in the voice-communication software or in the search-interface-dynamic-web-page to the voice-communication server or other such server of any website connected to the web. Then, the search programs in a server of the website will automatically access the database in such website to perform searching comparison to screen and to select out a voice-communication host IP address matching with such numerical code. Thus, the user is immediately connected to the corresponding voice-communication host IP address of a person or a company automatically in order to let such voice-communication caller achieve the purpose of sending a voice-communication to the subjective recipient's specific voice-communication device. Thus, the call recipient is enabled to receive the “Voice Message Request” from the caller, and then to proceed with a voice communication with such caller via the Internet low fare rate.

### BRIEF DESCRIPTION OF THE DRAWINGS

FIG. 1 is a block diagram illustrating a flow procedure for the first preferred embodiment of the present invention.

FIG. 2 is a flow chart of the search program in PHP software language in the search-interface dynamic-web-page of the present invention.

FIG. 3 is a flow chart of the comparison program in PHP software language of the present invention.

FIG. 4 is a block diagram illustrating a flow procedure in the second preferred embodiment of the present invention.

FIG. 5 is a block diagram illustrating a flow procedure in the third preferred embodiment of the present invention.

FIG. 6 is a block diagram illustrating a flow procedure in the fourth preferred embodiment of the present invention.

FIG. 7 is a block diagram illustrating a flow procedure in the fifth preferred embodiment of the present invention.

FIG. 8 is a block diagram illustrating a flow procedure in the sixth preferred embodiment of the present invention.

FIG. 9 is a block diagram illustrating a flow procedure in the seventh preferred embodiment of the present invention.

FIG. 10 is a block diagram illustrating a flow procedure in the eighth preferred embodiment of the present invention.

FIG. 11 is a block diagram illustrating a flow procedure in the ninth preferred embodiment of the present invention.

FIG. 12 is a block diagram illustrating a flow procedure in the tenth preferred embodiment of the present invention.

### DETAILED DESCRIPTION OF THE PREFERRED EMBODIMENTS

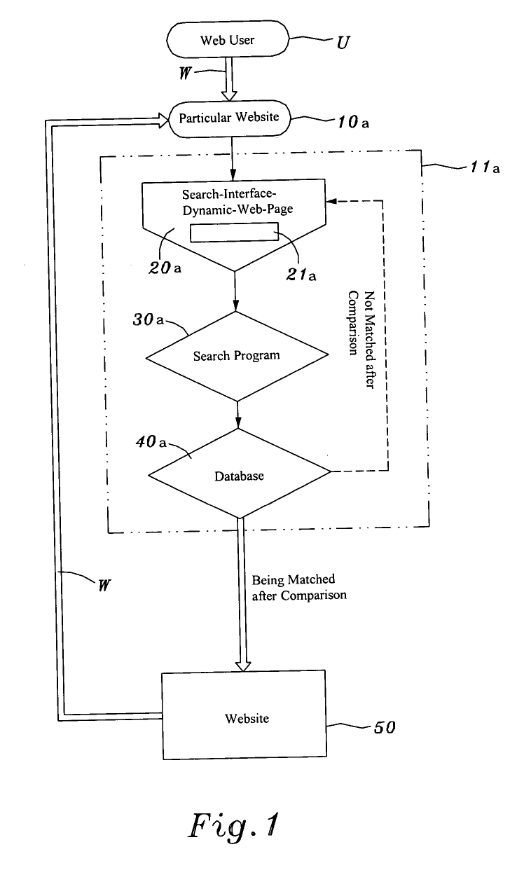

FIG. 1 illustrates a first preferred embodiment for searching a specific computer IP address of Internet networks using several specific telephone numbers in series which are arranged and composed in sequence with additional identification codes, according to the invention. The method uses a particular website 10a, a search-interface-dynamic-web-page 20a, a search program 30a and a database 40a.

The particular website server 11a of website 10a is connected to the Internet W and its inputs and outputs are compatible with all kinds of transfer protocols used in the Internet.

The search-interface-dynamic-web-page 20a is composed of a software language compatible with the Internet, is the home page or any subsequent web page of website 10a, and contains a code input field 21a that enables orderly key-in of a country-code-number, area-code-number, local-telephone-number, and identification-code.

Search programs 30a are composed in a software language applicable in the Internet and will automatically run after a user U of the Internet has input the “country-code-number+area-code-number+local-telephone-number+identification-code.”

Database 40a, which is loaded in such particular website server 11a of such particular website 10a, internally contains and stores each specific domain name and its IP address of the website server, and all their corresponding telephone numbers with identification codes.

All the search-interface-dynamic-web-pages 20a, 20b, 20c and all the search programs 30a, 30b, 30c to be described in every following embodiment of the present invention are written in PHP software language. However, other software languages such as XHTML, XML, VB Script, ASP, CSS, JSP, C, C++, CGI20, Java, ActiveX etc. may of course be substituted.

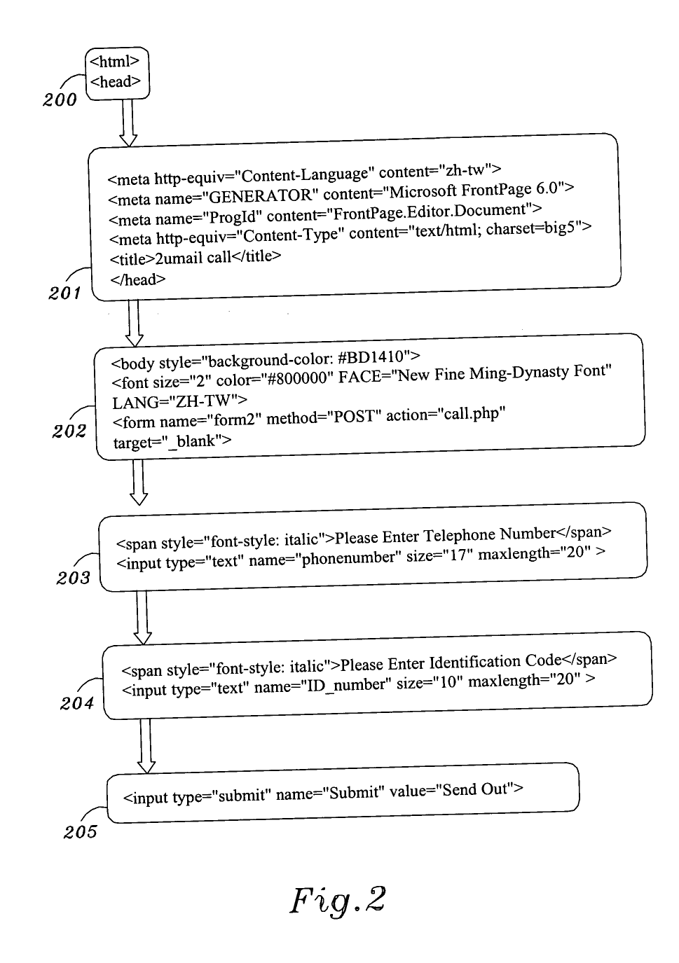

FIG. 2 illustrates the search-interface-dynamic-web-page programs 200, 201, 202, 203, 204 and 205 used in each search-interface-dynamic-web-page 20a, 20b, 20c of the various embodiments of the present invention. The functions of the programs are as follows:

Program 200: Ensures the syntax of the software language being used to compose all the search-interface-dynamic-web-pages 20a, 20b . . . (hereinafter, webpages 20s) is the same as that of the website browser.

Program 201: Enables all the search-interface-dynamic-web-page 20s to Hyperlink in the Internet.

Program 202: Informs the searching path to look for the formats of all fields in the table on all the search-interface-dynamic-web-page 20s.

Program 203: Provides code input fields 21s in all the search-interface-dynamic-web-page 20s that enables the user to input the numerical code(s) for known specific telephone numbers.

Program 204: Provides a code input field 21s in all the search-interface-dynamic-web-page 20s that enables the user to input of the known identification.

Program 204: Executes the command of “sending out” after carrying out the program 204.

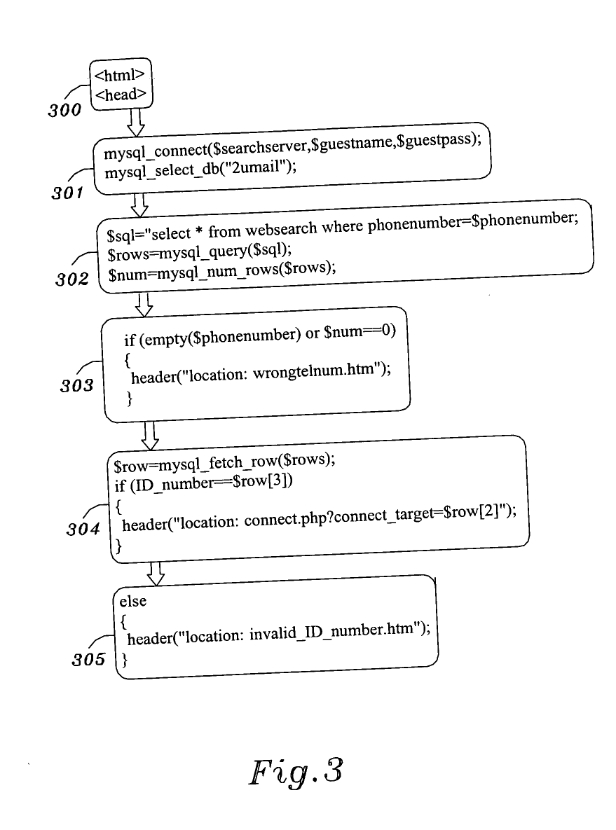

FIG. 3 illustrates the component programs 300, 301, 302, 503, 304 and 505 in each search program 30a, 30b, 30c for each of the embodiments of the present invention. The functions of the executing procedure are as follows:

Program 300: Ensures that the syntax of the software language being used to compose all these search programs 30s is the same as that of the website browser.

Program 301: Searches a path to look for an objective database.

Program 302: Looks for matched information in the objective database.

Program 303: Checks the content of the code input field 21, sets an “unsuccessful flag,” and sends it to the search-interface-dynamic-web-page 20 to ask for reentry of the correct telephone number or identification code information if an unfilled blank is present or the telephone number codes or identification code being filled in the code input field 21 does not correspond to ones that might be in the database.

Program 304: Compares the telephone number codes and identification code in the code input field 21 with those in the database, initiates a “successful” flag, and then execute the command of “sending out” an IP address if any matched pair is detected. The IP address can be designated as any one of the IP addresses of the website server, an e-mail IP address, or the IP address of a voice-communication device.

Program 305: Executes a comparison as in the program 304, initiates the “unsuccessful” flag, and then sends it to the search-interface-dynamic-web-page 20 to ask for reentry of the correct telephone number information, if no matched pair is detected.

Referring to FIGS. 1, 2 and 3, when a user of the Internet having information about a numerical code corresponding to a website that the user wants to visit, and that consists of exclusive telephone numbers or cellular phone numbers plus the identification code of a person or a company, the user can first access the particular website 10a through the Internet W, then click on the search-interface-dynamic-web-page 20a of the particular website 10a. Subsequently, the user can sequentially key a specific “country-code-number+area-code-number+local-telephone-number or cellular-phone-number+identification-code,” corresponding to such IP address into the code input field 21a through the search-interface-dynamic-web-page 20a in the particular website server 11a of website 10a.

Next, as shown in FIG. 2, each of the component programs 200, 201, 202, 203, 204 and 205 in search-interface-dynamic-web-page 20a will progressively execute its commands and initiate the search program 30a. Afterward, as shown in the FIG. 3, each component program 300, 301, 302, 303, 304 and 305 in the search program 30a will successively execute its respective commands. As a result, the comparison of all the “telephone numbers and identification code” as well as the corresponding “domain name” in database 40a takes place automatically.

After the comparison of the telephone numbers and identification code in search-interface-dynamic-web-page 20a and all those in database 40a, the following results are possible:

If matched information is found, the specific domain name of the matched telephone numbers and identification code will actively hyperlink to the IP address of the particular website 50 corresponding to the domain name. Then, every web page in the particular website 50 is enabled to replace search-interface-dynamic-web-page 20a in the previous particular website 10a. Alternately, a new web page in the particular website 50 is initiated to allow the user U of the Internet to successfully access and browse the particular website 50 immediately.

Contrarily, if no matched telephone numbers and identification code is found after all component programs 300, 301, 302, 303, 304 and 305 in the search program 30a have been executed, the program 305 will send out a command of “please reenter the correct telephone numbers and identification code” to the search-interface-dynamic-web-page 20a. Thus, user U of the Internet is informed to requisitely key in again a new correct telephone numbers and identification code to the code input field 21a in the search-interface-dynamic-web-page 20a in order to proceed with another comparison.

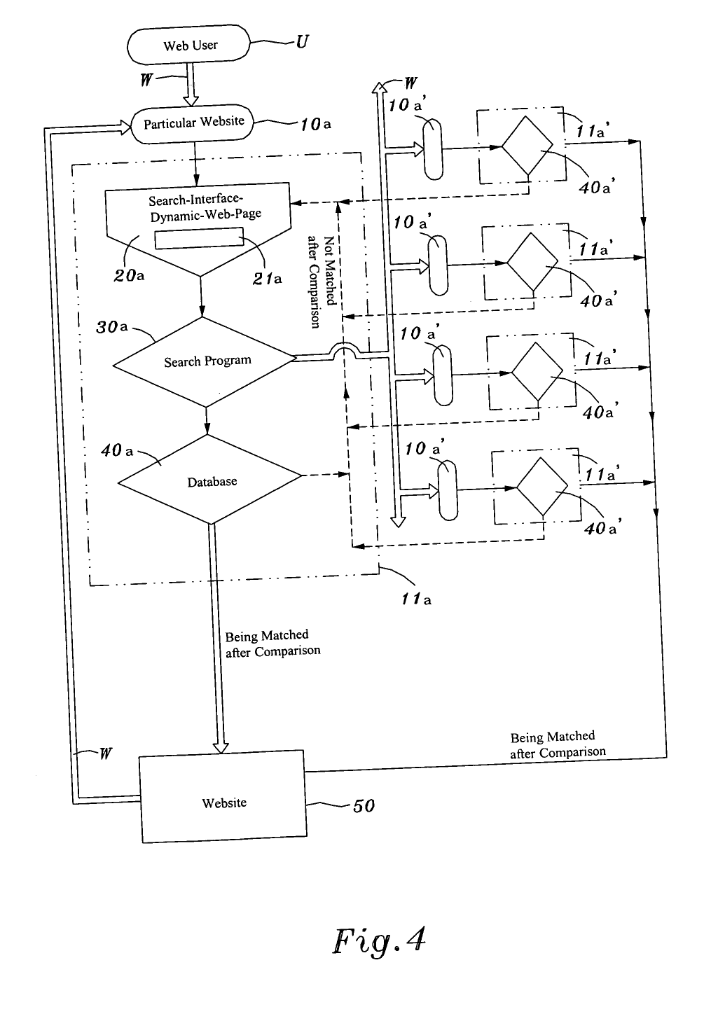

Referring to FIG. 4, illustrated is the second preferred embodiment of the present invention. The embodiment includes a database 40a′ in each website server 11a′ of each other website 10a′ connected to the Internet, which is in addition to database 40a in such website server 11a of such website 10a. The several databases 40a′ have stored therein each particular registered domain name and its corresponding IP address of the website server and all the telephone numbers plus identification code corresponding to each particular domain name and its corresponding IP address of the website server.

When a user of the Internet has information about the numerical code corresponding to a website that the user wants to visit, the numerical code consisting of exclusive telephone numbers or cellular phone numbers plus an identification code of a person or a company, the user can first access the particular website 10a through the Internet W, then click the search-interface-dynamic-web-page 20a of the particular website 10a. Subsequently, he can sequentially key-in a specific “country-code-number+area-code-number+local-telephone-number or cellular-phone-number+identification-code,” corresponding to such IP address into the code input field 21a through the search-interface-dynamic-web-page 20a in the particular website server 1a of the particular website 10a.

Then, search programs 30a are executed, and concurrently the searching comparison of database 40a in website server 11a of website 10a, and of all databases 40a′ in each other website server 11a′ of each other website 10a connected to the Internet, takes place automatically.

After the comparison of telephone numbers and identification code in such search-interface-dynamic-web-page 20a, and all those in such database 40a and 40a′, there are several possible results, as follows:

If matched information is found, the specific domain name of the matched telephone numbers and identification code will actively hyperlink to the IP address of the particular website 50 corresponding to the domain name. Then, every web page in the particular website 50 is enabled to replace search-interface-dynamic-web-page 20a in the previous particular website 10a. Alternately, a new web page in the particular website 50 is initiated to allow the user U of the Internet to successfully access and browse each particular website 50 immediately.

Contrarily, if no matched telephone numbers and identification code are found after all component programs 300, 301, 302, 303, 304 and 305 in such search program 30a have been executed, the program 305 will send out a command of “please reenter the correct telephone numbers and identification code to the search-interface-dynamic-web-page 20a. Thus, the user U of the Internet is informed to requisitely key in again new correct telephone numbers and identification code to code input field 21a in the search-interface-dynamic-web-page 20a in order to proceed with another comparison.

The “identification code” in the first and second embodiments described above is composed of any character, number or symbol, or any combination of characters, numbers, and/or symbols, that appears on the keyboard of the computer. It is arbitrarily designated by the website manager himself and can be changed willfully whenever.

The website manager of some particular business application can screen and control the candidates of website visitors by control of who is provided with the identification code. Thus, not only is the domain name replaced by the telephone number, but the code precludes improper invasion, congestion and collapse by the website visitor, because the website visitor who lacks information about the identification code will fail to access the website even though he knows the telephone numbers related.

Therefore, the present invention allows only people with legitimate business to visit a particular website. In case of the identification code being deciphered, it can be changed immediately to remedy it. So, it really has incalculable value in application and practicability.

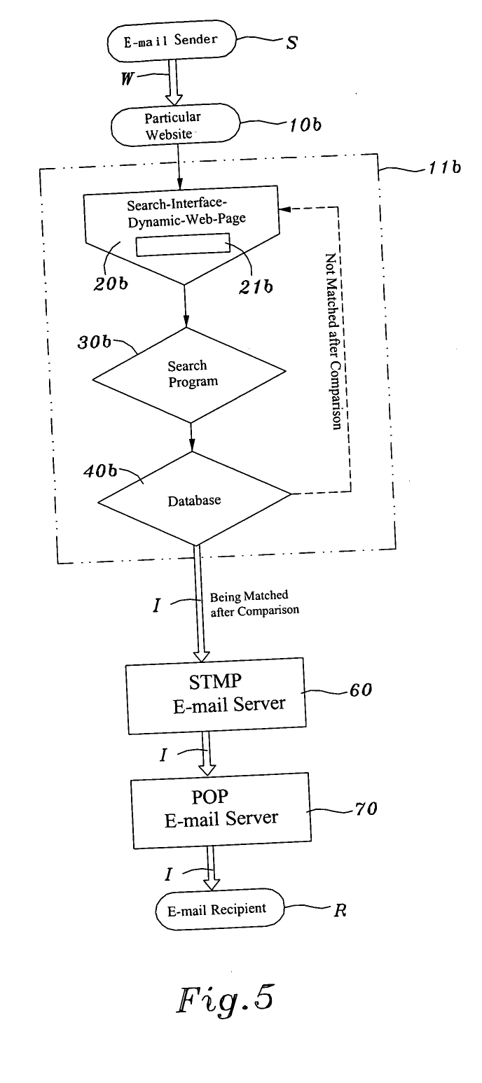

Referring to FIG. 5, illustrated is the third preferred embodiment of the present invention. Such method is used in e-mail or web-based messaging and is implemented by means of a particular website 10a, a search-interface-dynamic-web-page 20a, a search program 30a and a database 40a.

The particular website server 11b of such particular website 10b is connected to the Internet W and its inputs and outputs are all compatible with all kinds of transfer protocol in the Internet.

The search-interface-dynamic-web-page 20b, which is composed of software language applicable in the Internet, is the home page or any subsequent web page of the particular website 10b, and contains a code input field 21b into which the “country-code-number+area-code-number+local-telephone-number+identification-code” may be keyed-in.

Search program 30b, which is composed by software language applicable in the Internet, will automatically run after the sender S of the e-mail having input the “country-code-number+area-code-number+local-telephone-number+identification-code.”

Database 40b, which is loaded in the particular website server 11b of the particular website 10a, internally contains and stores each specific domain name and its IP address of the website server, and all their corresponding telephone numbers with identification codes.

Referring to FIGS. 2, 3 and 5, when a sender S of the e-mail has drafted an e-mail and has information on the numerical code corresponding to the objective e-mail address of a recipient person or company, where the numerical code consists of exclusive telephone numbers or cellular phone numbers plus the identification code of the person or a company, sender S accesses the particular website 10b by connecting to the Internet (www) by means of either cable transmission (example: city telephone line or CATV cable etc.) or wireless transmission (example: cellular phone or satellite telephone etc.).

After accessing the particular website 10b through the Internet W, the sender S can click on the search-interface-dynamic-web-page 20b of the particular website 10b. Subsequently, he can orderly key-in the “country-code-number+area-code-number+local-telephone-number or cellular-phone-number+identification-code” corresponding to the objective e-mail address into the code input field 21b through the search-interface-dynamic-web-page 20b in the particular website server 11b of the particular website 10b.

Next, as shown in FIG. 2, each of the component programs 200, 201, 202, 203, 204 and 205 in search-interface-dynamic-web-page 20b will progressively execute all of its own commands, and initiate the search program 30b. Afterward, as shown in FIG. 3, each of the component programs 300, 301, 302, 303, 304 and 305 in search program 30b will successively execute all of its commands. Then, the comparison of all the telephone numbers and identification code as well as the corresponding “e-mail address” in such database 40a takes place automatically.

After the comparison of telephone numbers and identification code in search-interface-dynamic-web-page 20b and all those registered in database 40b, the following results may be obtained:

If matched information is found, the specific e-mail address of such the matched telephone numbers and identification code will actively be transferred to the IP address of the SMTP e-mail server 60 associating with sender S through the Internet I immediately.

Next, the e-mail drafted by sender S is automatically transferred by SMTP e-mail server 60 through the Internet I to the IP address of the POP e-mail server 70 associated with recipient R.

Then, the e-mail can be retrieved and read by recipient R from POP e-mail server 70 through the Internet I.

Contrarily, if no matched telephone numbers and identification code are found after all component programs 300, 301, 302, 303, 304 and 305 in the search program 30a have been executed, the program 305 will send out a command of “please reenter the correct telephone numbers and identification code” to the search-interface-dynamic-web-page 20b. Thus, sender S of the e-mail is caused to requisitely key in again new correct telephone numbers and a new identification code to code input field 21b in search-interface-dynamic-web-page 20b in order to proceed with another comparison.

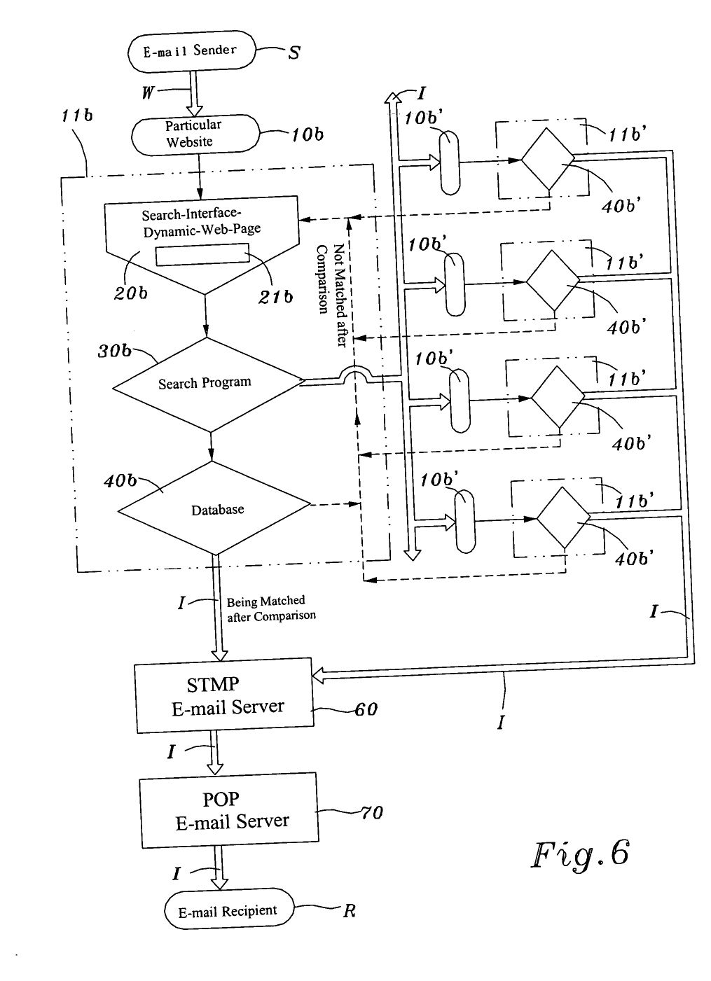

Referring to FIG. 6, illustrated is the fourth preferred embodiment of the present invention, in which databases 40b′ in other website servers 11b′ of other websites 10b′ connected to the Internet are utilized in addition to database 40b in website server 11b of website 10b. Each such database 40b′ has stored all e-mail addresses and corresponding IP addresses registered with the e-mail server, and all the telephone numbers plus identification code corresponding to each particular e-mail address and its corresponding IP address of the e-mail server.

Having the personal or company's telephone numbers and identification code that are exclusively used in e-mail by the objective recipient R, a sender S of the e-mail can orderly key the sequence “country-code-number+area-code-number+local-telephone-number or cellular-phone-number+identification-code” into the code input field 21b in the search-interface-dynamic-web-page 20b. Then, the search programs 30b are executed. Concurrently, the searching comparison of database 40b in website server 11b with all databases 40b′ in other website servers 11b′ connected to the World Wide Web takes place automatically.

After the comparison of telephone numbers and identification codes in search-interface-dynamic-web-page 20b, and all those registered in such database 40b, the following results are possible:

If matched information is found, the specific e-mail address of the matched telephone numbers and identification code will actively be transferred to the IP address of the SMTP e-mail server 60 associated with sender S through the Internet I immediately.

Next, e-mail drafted by the sender S is automatically transferred by SMTP e-mail server 60 through the Internet I to the IP address of the POP e-mail server 70 associated with recipient R.

Then, e-mail can be retrieved and read by recipient R from POP e-mail server 70 through the Internet I.

Contrarily, if no matched telephone numbers and identification code are found after all component programs 300, 301, 302, 303, 304 and 305 in search program 30a have been executed, the program 305 will send out a command of “please reenter the correct telephone numbers and identification code” to the search-interface-dynamic-web-page 20b. Thus, sender S of the e-mail is informed to requisitely key in a new correct telephone number and identification code to code input field 21b in search-interface-dynamic-web-page 20b in order to proceed with another comparison.

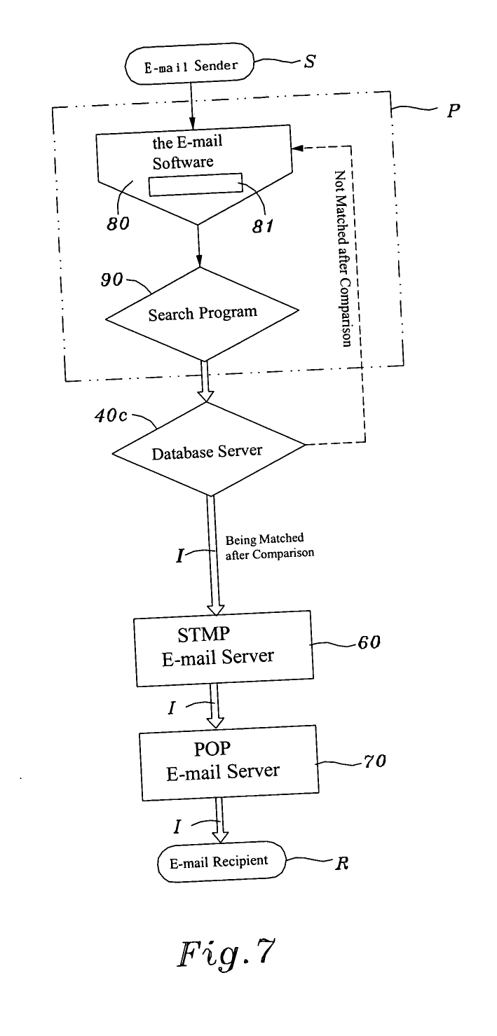

Referring to FIG. 7, illustrated is the fifth preferred embodiment of the present invention. This method is used in connection with e-mail of POP type, and is implemented by means of e-mail software 80, a search program 90 and a database server 40c.

The e-mail software 80 is installed in a computer P of the sender S, and a code input field 81 enables sequential input of the “country-code-number+area-code-number+local-telephone-number+identification-code.”

Search program 90, which is also installed in the computer P of the sender S, will automatically run after the sender S of the e-mail has input the “country-code-number+area-code-number+local-telephone-number+identification-code.”

Database server 40c, which is connected to the Internet I, internally registers and stores each specific e-mail address and the IP address of the corresponding e-mail server, and all corresponding telephone numbers with identification codes.

Referring to FIG. 7, when an e-mail Sender S selects POP type to send his e-mail, he first initiates the e-mail software 80 in the computer P.

Having the personal or company telephone numbers and identification code that are exclusively used in e-mail by the objective recipient R, the sender S can orderly key-in the sequence “country-code-number+area-code-number+local-telephone-number or cellular-phone-number+identification-code” into the code input field 81 in e-mail software 80. Then, the search programs 90 will be initiated. By means of either cable transmission (example: city telephone line or CATV cable etc.) or wireless transmission (example: cellular phone or satellite telephone etc.), the sender's computer P can be connected to the database server 40c and, concurrently, the searching comparison of all e-mail addresses in the database 40c with all IP addresses of the corresponding e-mail server takes place automatically.

After the comparison of telephone numbers and identification code in code input field 81 of e-mail software 80, and all those registered in such database 40c, the following results are possible:

If matched information is found, the specific e-mail address of the matched telephone numbers and identification code will actively be transferred to the IP address of the SMTP e-mail server 60 associated with sender S through the Internet I immediately.

Next, e-mail drafted by sender S is automatically transferred by SMTP e-mail server 60 through the Internet I to the IP address of the POP e-mail server 70 associated with such recipient R.

Then, the e-mail can be retrieved and read by recipient R from POP e-mail server 70 through the Internet I.

Contrarily, if no matched telephone numbers and identification code are found after search program 90 has been executed, it will send out a command of “please reenter the correct telephone numbers and identification code” to e-mail software 80. Thus, sender S of the e-mail is informed to requisitely key in again new correct telephone numbers and a new identification code to code input field 81 in e-mail software 80, in order to proceed with another comparison.

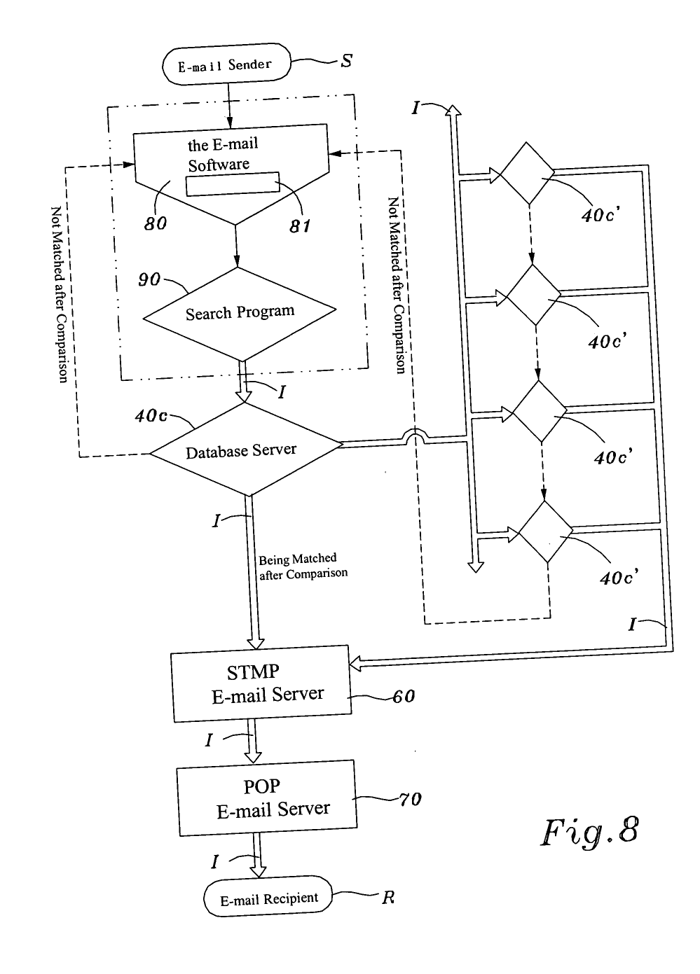

Referring to FIG. 8, illustrated is the sixth preferred embodiment of the present invention, which utilizes database servers 40c′ connected to the Internet I in addition to database server 40c. The database servers 40c′ have stored therein each registered e-mail address and its corresponding IP address of the e-mail server, and all the telephone numbers plus identification codes corresponding to each particular e-mail address and the corresponding IP address of the e-mail server.

Referring to FIG. 8, when an e-mail Sender S selects POP type to send his e-mail, he first initiates the e-mail software 80 in the computer P.

When the sender S has the personal or company telephone numbers and identification code exclusively used in e-mail by the objective recipient R, the sender can orderly key the sequence “country-code-number+area-code-number+local-telephone-number or cellular-phone-number+identification-code” into code input field 81 in e-mail software 80. Then, the search programs 90 are initiated. By means of either cable transmission (example: city telephone line or CATV cable etc.) or wireless transmission (example: cellular phone or satellite telephone etc.), the sender's computer P can be connected to the database server 40c and all other database servers 40c′, and concurrently the searching comparison of all e-mail addresses in database server 40c and 40c′, with all IP addresses of the corresponding e-mail server, takes place automatically.

After the comparison of the telephone numbers and identification code in code input field 81 in e-mail software 80 and all those registered in database server 40c and 40c′, the following results are possible:

If matched information is found, the specific e-mail address of the matched telephone numbers and identification code will actively be transferred to the IP address of the SMTP e-mail server 60 associated with sender S through the Internet I immediately.

Next, e-mail drafted by sender S is automatically transferred by SMTP e-mail server 60 through the Internet I to the IP address of the POP e-mail server 70 associated with recipient R.

Then, such e-mail can be retrieved and read by such recipient R from such POP e-mail server 70 through the Internet I.

Contrarily, if no matched telephone numbers and identification code are found after search program 90 have been executed, it will send out a command of “please reenter the correct telephone numbers and identification code” to e-mail software 80. Thus, sender S of the e-mail is informed to requisitely key in again new correct telephone numbers and a new identification code to code input field 81 in e-mail software 80, in order to proceed with another comparison.

The “identification code” in the third, forth, fifth, and sixth embodiments described above is composed of any character, number or symbol, or any combination of characters, numbers, and/or symbols, that appears on the keyboard of the computer. It is arbitrarily designated by the sender or recipient himself and can be changed willfully whenever.

Thus, not only can the lengthy and difficult-to-memorize e-mail address be replaced by a simple-to-memorize telephone number, but improper invasion, congestion and collapse of a website can be precluded because the website visitor, without information of such “identification code,” will fail to access the website even though he knows the appropriate telephone numbers.

Therefore, the present invention allows legitimate exchange of e-mails while precluding unwanted e-mails. In case of the “identification code” being deciphered, it can be changed immediately to remedy it. So, it is really a good way to solve problems of the e-mail exchange.

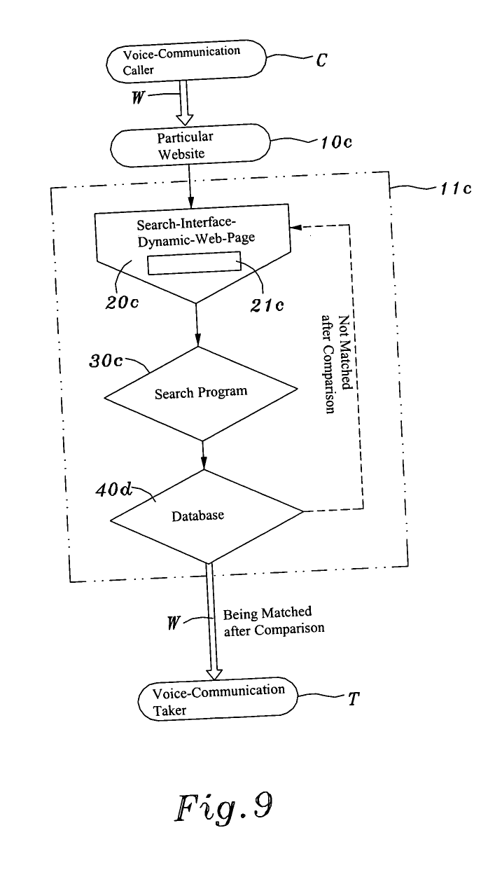

FIG. 9 illustrates a seventh preferred embodiment of the present invention, which again is implemented by means of a particular website 10c, a search-interface-dynamic-web-page 20c, a search program 30c and a database 40c, where the website server 11c of website 10c is connected to the Internet I and its inputs and outputs are compatible with all kind of transfer protocols used in the Internet.

Search-interface-dynamic-web-page 20c is composed in a software language applicable in the Internet, is the home page or any subsequent web page of website 10c, and contains a code input field 21c for enabling the “country-code-number+area-code-number+local-telephone-number+identification-code” to be sequentially keyed-in.

Search program 30c is also composed in any software language applicable to the World Wide Web or Internet I, and will automatically run after the caller C has input the “country-code-number+area-code-number+local-telephone-number+identification-code.”

Database 40d, which is loaded in website server 11c of website 10c, internally registers and stores each specific computer IP address of a voice-communication-device together with the telephone numbers with identification codes corresponding to the computer IP addresses of the voice-communication device (or host computer to which the device is connected).

If a caller C wants to call a taker T to start on-line voice-communication via the Internet or World Wide Web, the caller may perform or have performed the steps of the embodiment as shown in FIG. 9.

Referring to FIGS. 2, 3 and 9, the caller can first access the particular website 10c through the Internet or World Wide Web by means of either cable transmission (for example, a city telephone line or CATV cable, etc.) or wireless transmission (for example, a cellular phone or satellite telephone, etc.).

After accessing the particular website 10c through the Internet I, the caller can click the search-interface-dynamic-web-page 20c of particular website 10c.

Subsequently, he can key-in the specific “country-code-number+area-code-number+local-telephone-number+identification-code” or “country-code-number+cellular-phone-number+identification-code” into the code input field 21c through the search-interface-dynamic-web-page 20c in the particular website server 11c of website 10c, where the telephone number corresponds to the IP address of a voice-communication device.

Next, each component program 200, 201, 202, 203, 204 and 205 (as shown in the FIG. 2) in such search-interface-dynamic-web-page 20c will progressively execute all its commands, and initiate the search program 30c. Afterward, each component program 300, 301, 302, 303, 304 and 305 (as shown in the FIG. 3) in search program 30c will successively execute all the commands of its own individually. Then, the comparison of telephone numbers and identification code to obtain IP address of the voice-communication device in database 40d takes place automatically.

After comparing the telephone number and identification code input into search-interface-dynamic-web-page 20b with corresponding telephone numbers and identification codes registered in database 40b, the following results may be obtained:

If matched information is found, the specific “IP address of the voice-communication device” of the matched “telephone-numbers and identification code” will actively be transferred to the IP address of the voice-communication device associated with taker T through the Internet I immediately. Thus, the taker T is enabled to receive the “Voice Message Request” from caller C, and to proceed with a voice communication with caller C via the Internet at a relatively low cost.

Contrarily, if no matched “telephone-numbers and identification code” is found after all component programs 300, 301, 302, 303, 304 and 305 in search program 30c have been executed, program 305 will send out a command of “please reenter the correct telephone numbers and identification code” to search-interface-dynamic-web-page 20c. Thus, caller C is informed to again key-in new correct telephone numbers and identification code to code input field 21c in search-interface-dynamic-web-page 20c in order to proceed with another comparison.

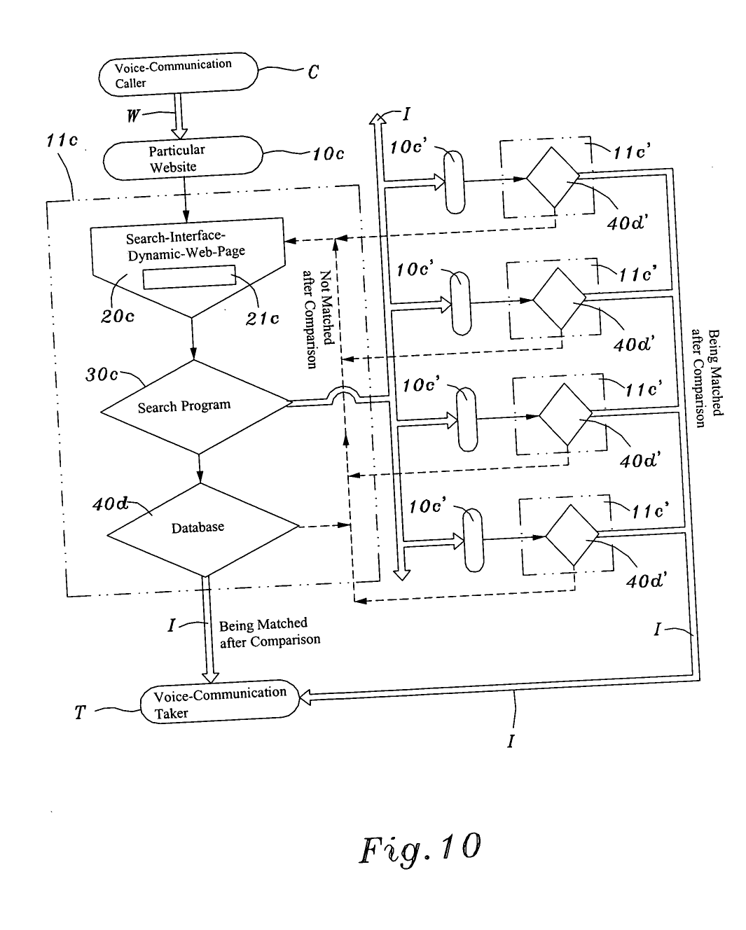

Referring to FIG. 10, illustrated is the eighth preferred embodiment of the present invention, which utilizes additional databases 40d′ in other website servers 11c′ of other websites 10c′ connected to the Internet, the additional databases 40d′ having stored IP addresses of voice-communication devices and all of the telephone numbers plus identification code corresponding to the IP addresses of the voice-communication devices.

Having a personal or company's telephone numbers and identification code, which are exclusively used for voice-communication by the phone call taker T, a caller C can key the sequence “country-code-number+area-code-number+local-telephone-number or cellular-phone-number+identification-code” into the code input field 21c in the search-interface-dynamic-web-page 20c. Then, the search programs 30c will be initiated to determine whether the telephone numbers of the taker correspond to an IP address of a voice-communication device the taker, at which time, databases 40d in website server 11c and databases 40d′ in other website servers 11c′ connected to the World Wide Web are automatically searched.

After the comparison of the telephone number and identification code input to the search-interface-dynamic-web-page 20c with telephone numbers and identification codes registered in database 40d and databases 40d′, the following results may be obtained:

If having matched information is found, the specific IP address of the voice-communication device” of the matched telephone numbers and identification code will actively be transferred to the IP address of the voice-communication device associated with taker T through the Internet I immediately. Thus, taker T is enabled to receive the “Voice Message Request” from caller C, and to proceed with voice communication with caller C via the Internet at reduced cost.

Contrarily, if no matched telephone-numbers and identification code is found after all component programs 300, 301, 302, 303, 304 and 305 in search program 30c have been executed, the program 305 will send out a command of “please reenter the correct telephone numbers and identification code” to search-interface-dynamic-web-page 20c. Thus, caller C is informed to requisitely key in again a new “correct telephone numbers and identification code” to code input field 21c in search-interface-dynamic-web-page 20c in order to proceed with another comparison.

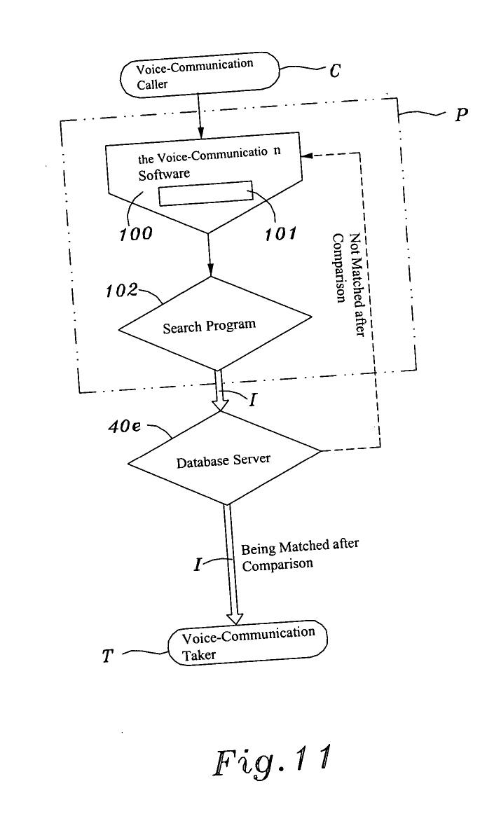

Referring to FIG. 11, illustrated is the ninth preferred embodiment of the present invention, which is implemented by means of voice-communication software 100, a search program 102 and a database server 40e, and in which voice-communication software 100 is installed in the computer P of the caller C, and a code input field 101 is provided to enable input of the “country-code-number+area-code-number+local-telephone-number+identification-code.”

Search program 102, which is also installed in the computer P of the caller C, will automatically run after the caller C has input the “country-code-number+area-code-number+local-telephone-number+identification-code” sequentially;

Database server 40e, which is connected to the World Wide Web or the Internet I, internally registers and stores each specific IP address of the voice-communication device and all the telephone numbers with identification codes corresponding to the specific IP addresses of the voice-communication device.

If a caller C wants to call a taker T to start on-line voice-communication via the Internet or World Wide Web, the caller may perform, or cause to be performed, the steps illustrated in FIG. 11.

The caller first actuates the voice-communication software 100 in his computer P.

Subsequently, he or she can key-in the specific “country-code-number+area-code-number+local-telephone-number+identification-code” or “country-code-number+cellular-phone-number+identification-code” into the code input field 101 through such voice-communication software 100. Afterwards, the search programs 102 will be initiated to determine the IP address of a voice-communication device of the taker.

Thereafter, the caller's computer is connected to a database server 40e in the Internet or World Wide Web by means of either cable transmission (example: city telephone line or CATV cable etc.) or wireless transmission (example: cellular phone or satellite telephone etc.).

Then, the comparison of all the telephone-numbers and identification code as well as all IP addresses of the voice-communication device in the database 40c takes place automatically.

After the comparison of telephone-numbers and identification code in the code input field 101 of the voice-communication software 100 and with telephone numbers and identification codes registered in database 40e, the following results may be obtained:

If matched information is found, the specific IP address of the voice-communication device of the matched telephone numbers and identification code will actively be transferred to the IP address of the voice-communication device associated with taker T through the Internet I immediately. Thus, taker T is enabled to receive the “Voice Message Request” from caller C, and to proceed with voice communication with caller C via the Internet at low cost.

Contrarily, if no matched telephone-numbers and identification code is found after all search programs 102 of the voice-communication software 100 have been executed, the search programs 102 will send out a command of “please reenter the correct telephone numbers and identification code” to voice-communication software 100. Thus, caller C is informed to requisitely key-in again new correct telephone numbers and/or a new identification code to code input field 101 in voice-communication software 100 in order to proceed with another comparison.

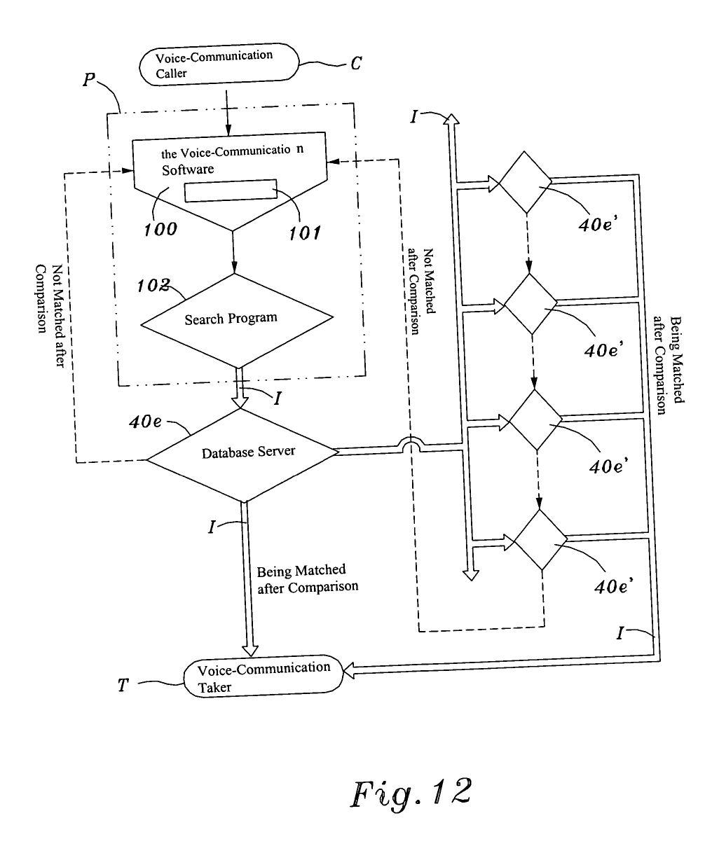

Referring to FIG. 12, illustrated is the tenth preferred embodiment of the present invention, in which additional databases 40e′ connected to the Internet I are utilized, the additional databases 40e′ having stored therein each particular IP address of voice-communication devices registered in the databases and all the telephone numbers plus identification code corresponding to each particular IP address of the voice-communication device.

If a caller C wants to call taker T to start on-line voice-communication via the Internet or World Wide Web, the caller may perform or cause to perform the steps shown in FIG. 12.

The caller first actuates the voice-communication software 100 in his computer P.

Subsequently, he or she keys the specific “country-code-number+area-code-number+local-telephone-number+identification-code” or “country-code-number+cellular-phone-number+identification-code” into the code input field 101 through voice-communication software 100. Afterwards, the search programs 102 are initiated to located a corresponding IP address of a voice-communication device of the taker.

Thereafter, the caller's computer can be connected to database server 40e and all other database servers 40e′ in the Internet or World Wide Web by means of either cable transmission (example: city telephone line or CATV cable etc.) or wireless transmission (example: cellular phone or satellite telephone etc.).

Then, the comparison of all the telephone-numbers and identification codes to obtain the IP address of the voice-communication device in databases 40e and 40e′ takes place automatically.

After the comparison of the telephone-numbers and identification code in code input field 101 of the voice-communication software 100 with corresponding numbers and codes registered in databases 40e and all 40e″, several results are possible:

If matched information is found, the specific IP address of the voice-communication device of the matched telephone numbers and identification code will actively be transferred to the IP address of the voice-communication device associated with taker T through the Internet I immediately. Thus, taker T is enabled to receive the “Voice Message Request” from caller C, and to proceed with voice communication with caller C via the Internet at a relatively low cost.

Contrarily, if no matched telephone-numbers and identification code is found after all search programs 102 of the voice-communication software 100 have been, the search programs 102 will send out a command of “please reenter the correct telephone numbers and identification code” to voice-communication software 100. Thus, caller C is informed to requisitely key in again new correct telephone numbers and/or a new correct identification code to code input field 101 in voice-communication software 100 in order to proceed with another comparison.

The “identification code” in the seventh, eighth, ninth, and tenth embodiments described above is composed of any character, number or symbol, or any combination of characters, numbers, and/or symbols, that appears on the keyboard of the computer. It is arbitrarily designated by the sender or recipient himself and can be changed willfully whenever.

Thus, not only is the specific IP address of the voice-communication device replaced by the telephone number to facilitate locating the IP address, but improper harassment by irrelevant or unknown people is also precluded because the people without information of such “identification code” will not be successful in locating the IP address through the telephone numbers alone, without the extra identification code. Therefore, the present invention limits on-line voice-communication attempts to those who know the taker's identification code. In case of the “identification code” is compromised, it can be changed immediately to remedy the problem, which is a really good way to solve the problem of Internet-phone harassment.

1. A method of searching for a specific computer IP address on the Internet using telephone number codes and an identification code, comprising the steps of:
upon input by a user of a telephone number and an identification code, using a search program to search a database of telephone numbers and identification codes for a match; and
if a match is found, retrieving an IP address associated with the input telephone number and identification.

2. A method of searching for a specific computer IP address on the Internet using telephone number codes and an identification code, comprising the steps of:
sequentially inputting a telephone number and an identification code or a mobile phone number and an identification-code;
searching a data of telephone numbers and identification codes for a match to the telephone number or mobile phone number and the identification code of the input codes;
if a match is found, retrieving an IP address associated with the input telephone number or mobile phone number and the identification code.

3. The method, as recited in claim 1, wherein the IP address stored in said database is an IP address of a particular website server.

4. The method, as recited in claim 1, wherein said particular computer IP address stored in said database is an IP address of an e-mail server.

5. The method, as recited in claim 1, wherein said particular computer IP address stored in such database is an IP address of a voice-communication device.

6. The method, as recited in claim 1, wherein said telephone number codes and the identification code include: “country-code-number+area-code-number+local-telephone-number and identification-code” or “country-code-number+cellular-telephone-number and identification-code”.

7. The method, as recited in claim 1, wherein the identification-code is composed of any character, number or symbol, or any combination of characters, numbers, and/or symbols, that appears on the keyboard of the computer.

8. The method, as recited in claim 1, wherein the step of using a search program to search the database comprises the step of searching databases on a plurality of servers connected to the Internet, each server internally registering and storing each specific computer IP address associated with the respective server, and all telephone numbers with identification codes, corresponding to each specific computer IP address.

9. The method, as recited in claim 1, wherein said search program is arranged to search any database in any website server connected to the World Wide Web or the Internet.

10. The method, as recited in claim 1, wherein the IP address of said particular website server includes each specific domain name and IP address associated with the website server, and all corresponding telephone numbers with identification codes.

11. A method of searching for a specific computer IP address on the Internet using telephone number codes and an identification code, comprising the steps of:
providing e-mail software installed in a computer of the sender, the e-mail software having a code input field for inputting the telephone number codes and the identification code sequentially;
automatically executing a search program installed in the computer of the sender, after the sender S of the e-mail has input the “country-code-number+area-code-number+local-telephone-number+identification-code” in order to compare with corresponding telephone number codes and identification codes stored in a database of a database server connected to the World Wide Web or Internet, the database server internally registering and storing specific computer IP addresses and all telephone number codes and identification codes corresponding to the specific computer IP addresses; and
if a match is found, sending the e-mail to a specific computer IP address associated with the telephone number codes and identification code.

12. The method, as recited in claim 11, wherein said specific computer IP address stored in such database is the IP address of a particular e-mail server.

13. The method, as recited in claim 11, wherein said telephone number codes and identification code includes: “country-code-number+area-code-number+local-telephone-number and identification-code” or “country-code-number+cellular-telephone-number and identification-code”.

14. The method, as recited in claim 11, wherein the identification-code is composed of any character, number or symbol, or any combination of characters, numbers, and/or symbols, that appears on the keyboard of the computer.

15. The method, as recited in claim 11, wherein said database server further includes other servers connected to the World Wide Web or the Internet, and each server internally registers and stores each specific computer IP and all telephone number codes and the identification code corresponding to each specific computer IP.

16. The method, as recited in claim 11, wherein said search program searches databases in servers other than said database server that are connected to the World Wide Web or the Internet.

17. A method of searching for a specific computer IP address on the Internet using telephone number codes and an identification code, comprising the steps of:
providing voice-communication software installed in a device of the caller, the voice-communication software having a code input field for inputting the telephone number codes and identification code;
automatically executing a search program installed in the device of the caller, after the caller has input the “country-code-number+area-code-number+local-telephone-number and identification-code” in order to compare with corresponding telephone number codes and identification codes stored in a database of a database server connected to the World Wide Web or Internet, the database server internally registering and storing specific IP addresses associated with voice-communication devices and all telephone number codes and identification codes corresponding to the specific IP addresses; and
if a match is found, sending the voice-communication to one of said specific IP addresses.

18. The method, as recited in claim 17, wherein at least one of said specific IP addresses stored in such database is an IP address of a specific voice-communication device.

19. The method, as recited in claim 17 wherein said telephone number codes and identification code include: “country-code-number+area-code-number+local-telephone-number and identification-code” or “country-code-number+cellular-telephone-number and identification-code”.

20. The method, as recited in claim 17, wherein the identification-code is composed of any character, number or symbol, or any combination of characters, numbers, and/or symbols, that appears on the keyboard of the computer.

21. The method, as recited in claim 17, wherein said database server farther includes other servers connected to the World Wide Web or the Internet, and each server internally registers and stores each specific voice-communication device IP address and all telephone numbers and identification codes corresponding to each specific voice-communication device IP address.

22. The method, as recited in claim 17, wherein said search program searches databases in servers other than said database server that are connected to the World Wide Web or the Internet.
